(19) United States
(12) Patent Application Publication
(10) Pub. No.: US 2007/0037928 A1
(43) Pub. Date: Feb. 15, 2007

(54) Method for lowering the melt viscosity of an aromatic sulfone polymer composition, and method for manufacturing an aircraft component

(76) Inventor: Shari Weinberg, Atlanta, GA (US)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/547,744

(22) PCT Filed: Mar. 10, 2004
(86) PCT No.: PCT/US04/05229

§ 371 Date: Jun. 27, 2006

(51) Int. Cl. C08L 81/00; C08G 75/00

(52) U.S. Cl. 525/189; 528/373

(57) ABSTRACT

Method for lowering the melt viscosity of an aromatic sulfone polymer composition consisting of at least one aromatic sulfone polymer and, optionally, one or more other ingredients [composition (1)], which comprises using an additive consisting of at least one fluorocarbon polymer comprising recurring units derived from at least one perfluorinated monoolefin and at least one perfluoroalkylvinylether and, optionally, one or more other ingredients [additive (A)]. Method for manufacturing an aircraft component comprising an aromatic sulfone polymer composition consisting of at least one aromatic sulfone polymer and, optionally, one or more other ingredients, which comprises applying to the aromatic sulfone polymer composition the above method for lowering its melt viscosity.

### CROSS-REFERENCE TO RELATED APPLICATIONS

The present application claims the benefit of U.S. application Ser. No. 60/452,960 filed Mar. 10, 2003 and U.S. application Ser. No. 60/517,406 filed Nov. 6, 2003.

### BACKGROUND OF THE INVENTION

1. Field of the Invention

This invention relates to a method for lowering the melt viscosity of an aromatic sulfone polymer composition; it relates also to a method for manufacturing an aircraft component comprising an aromatic sulfone polymer composition, which comprises applying to the aromatic sulfone polymer composition the above cited method for lowering its melt viscosity.

2. Description of the Background

For several years, the aircraft industry has required fire resistant and supertough materials for the manufacturing of aircraft interior components such as wall panels, overhead storage lockers, serving trays, seat backs, cabin partitions, and ducts. The basic requirements these materials have to comply with, are at best met by prior art aromatic sulfone polymer compositions. Aromatic sulfone polymers, especially polybiphenylethersulfones, offer indeed an attractive combination of properties, especially high fire resistance and supertoughness. Yet, existing aromatic sulfone polymer compositions are no more fully satisfactory, and we are even far from this.

The problem is that current aircraft industry trends have created the need for materials which have further a very high flowability. To the purpose of the present invention, a high flow material is intended to denote a material which has a low melt viscosity. High flow materials would make it possible notably to mold thin-walled, and consequently light-weight, aircraft interior components.

Another possible problem, which, the case being, adds to the first one, is that, while an increase in the flowability of the materials is searched for, their toughness has sometimes to be maintained at an extremely high level. Another possible problem, which, the case being, adds also possibly to the first one, is that still more fire resistant materials are sometimes needed.

None of the sulfone polymer compositions supplied into this market, in particular none of the commercially available aromatic polybiphenylethersulfone polymer compositions, offers desirable flowability. A fortiori, none of them offers a desirable combination of very high flowability, of very high fire resistance and of supertoughness.

While substantial search effort has already been allocated to the purpose of developing a method for increasing the fire resistance of aromatic sulfone polymer compositions, as will be detailed hereafter, the Applicant is not aware of any research which would have ever been conducted to the purpose of developing a method for lowering the melt viscosity of said aromatic polymer compositions.

U.S. Pat. No. 5,204,400 describes an aromatic sulfone polymer composition suitable for manufacturing aircraft interior components, comprising a polybiphenylethersulfone, a fluorocarbon polymer such as a polytetrafluoroethylene, and at least 2 pbw. of anhydrous zinc borate ; in this composition, the fluorocarbon polymer and the anhydrous zinc borate act synergistically to the purpose of increasing the flame retardancy of the aromatic sulfone polymer composition (see notably col. 21, 1. 50-53).

U.S. Pat. No. 5,916,958 describes an aromatic sulfone polymer composition, suitable for manufacturing aircraft interior components, comprising a polybiphenylethersulfone, a fluorocarbon polymer such as a polytetrafluoroethylene, and at least 3 pbw. of titanium dioxide; in this other composition, the fluorocarbon polymer and the titanium dioxide act also synergistically to the purpose of increasing the flame retardancy of the aromatic sulfone polymer composition (see notably col. 13, 1. 13-17).

The fire resistant (in particular, flame retardant) aromatic sulfone polymer compositions found adequate in prior years for use in demanding applications such as aircraft interiors are no longer acceptable, because none of them has a sufficiently low melt viscosity so as to produce very light-weight materials. A fortiori, none of them offers offer a desirable combination of very high flowability, very high fire resistance and supertoughness.

Accordingly, there remains a strong need for a method for lowering the melt viscosity of aromatic sulfone polymer compositions. Advantageously, said method should also increase the fire resistance and maintain the supertough behaviour of the aromatic sulfone polymer compositions.

### SUMMARY OF THE INVENTION

The present invention is based on the surprising effect of reduction of the melt viscosity of an aromatic sulfone polymer composition obtained by using an additive which comprises a fluorocarbon polymer comprising recurring units derived from at least one perfluorinated monoolefin and at least one perfluoroalkylvinylether.

An aspect of the present invention is to a method for lowering the melt viscosity of an aromatic sulfone polymer composition consisting of at least one aromatic sulfone polymer and, optionally, one or more other ingredients [composition (I)], which comprises using an additive consisting of at least one fluorocarbon polymer comprising recurring units derived from at least one perfluorinated monoolefin and at least one perfluoroalkylvinylether and, optionally, one or more other ingredients [additive (A)].

One embodiment of the present invention is to a method comprising:
providing the ingredient(s) of composition (I),
providing the ingredient(s) of additive (A), and
preparing an aromatic sulfone polymer composition consisting of the ingredient(s) of composition (I) and the ingredient(s) of additive (A) [composition (II)],
   wherein composition (II) has a melt viscosity lower than the melt viscosity composition (I).

Another embodiment of the present invention is where composition (II) has a viscosity measured at 380° C. under a shear rate of 498.6 s⁻¹ lower than 600 Pa·s.

Another embodiment of the present invention is where composition (II) has a viscosity measured at 380° C. under a shear rate of 498.6 s⁻¹ of less than ½ times the viscosity of composition (I), measured at the same temperature and under the same shear rate.

Another embodiment of the present invention is where composition (II) is supertough.

Another embodiment of the present invention is where composition (II) has an increased fire resistance than of composition (I).

Another embodiment of the present invention is where composition (II) has a heat release rate under fire conditions lower than composition (I).

Another embodiment of the present invention is where the aromatic sulfone polymer comprises at least one polybiphenylethersulfone.

Another embodiment of the present invention is where more than 80 wt. % of the aromatic sulfone polymer consists of the polybiphenylethersulfone.

Another embodiment of the present invention is where the aromatic sulfone polymer further comprises more than 20 wt. % of at least one bisphenol A polysulfone.

Another embodiment of the present invention is where the fluorocarbon polymer comprises recurring units derived from tetrafluoroethylene and perfluoromethylvinylether.

Another embodiment of the present invention is where composition (II) comprises less than 10 wt. %, based on the total weight of composition (II), of the fluorocarbon polymer.

Another embodiment of the present invention is where additive (A) further comprises a polymer selected from the group consisting of polyetherimides, polycarbonates, poly(aryl ether ketones), and liquid crystalline polymers.

Another embodiment of the present invention is where composition (II) is free of inorganic flame retardant or comprises inorganic flame retardant in an amount of less than 2 pbw. (based on the weight of the aromatic sulfone polymer). Anhydrous zinc borate is an example of inorganic flame retardant.

Another embodiment of the present invention is where composition (II) is free of titanium dioxide or comprises titanium dioxide in an amount of less than 3 pbw. (based on the weight of the aromatic sulfone polymer).

Another embodiment of the present invention is where composition (II) comprises titanium dioxide in an amount of at least 3 pbw. (based on the weight of the aromatic sulfone polymer).

Another aspect of the present invention is to a method for manufacturing an aircraft component comprising an aromatic sulfone polymer composition consisting of at least one aromatic sulfone polymer and, optionally, one or more other ingredients [composition (I)], which comprises applying to the aromatic sulfone polymer composition the method for lowering its melt viscosity as above described.

Another aspect of the present invention is to the use of an additive consisting of at least one fluorocarbon polymer comprising recurring units derived from at least one perfluorinated monoolefin and at least one perfluoroalkylvinylether and, optionally, one or more other ingredients [additive (A)], to lower the melt viscosity of an aromatic sulfone polymer composition consisting of at least one aromatic sulfone polymer and, optionally, one or more other ingredients [composition (I)].

Another aspect of the present invention is to a method for preparing an aromatic sulfone polymer composition in the need of lowering its melt viscosity, which comprises:
providing at least one aromatic sulfone polymer,
providing the ingredient(s) of an additive consisting of at least one fluorocarbon polymer comprising recurring units derived from at least one perfluorinated monoolefin and at least one perfluoroalkylvinylether, and optionally, one or more other ingredients [additive (A)], in an effective amount to lower the melt viscosity of the aromatic sulfone polymer composition,
optionally, providing one or more ingredients other than the aromatic sulfone polymer and the ingredient(s) of additive (A),
contacting, and advantageously mixing, the aromatic sulfone polymer, the ingredient(s) of additive (A) and, the case being, the ingredient(s) other than the aromatic sulfone polymer and the ingredient(s) of additive (A).

Another aspect of the present invention is to an aromatic sulfone polymer composition [composition (II)] comprising:
at least one aromatic sulfone polymer, and
an additive comprising at least one fluorocarbon polymer comprising recurring units derived from at least one perfluorinated monoolefin and at least one perfluoroalkylvinylether [additive (A)],
   wherein composition (II) has a melt viscosity lower than the melt viscosity of the same composition without additive (A) [composition (I)].

Another aspect of the present invention is to an aircraft component comprising composition (II).

One embodiment is where the aircraft component is selected from the group consisting of an overhead passenger service unit, a window reveal, an air return grill, an aircraft wall panel, an aircraft overhead storage locker, an aircraft serving tray, an aircraft seat back, an aircraft cabin partition, and an aircraft duct.

Finally, an aspect of the present invention is to an aircraft comprising the aircraft component as above described.

### DETAILED DESCRIPTION OF THE PREFERRED EMBODIMENTS

This invention pertains to the use of an additive of a specific type to lower the melt viscosity of an aromatic sulfone polymer composition. In one preferred aspect of the invention, the use of the additive offers increased fire resistance in addition to lower melt viscosity. In another preferred aspect of the invention, the use of the additive offers supertough behaviour in addition to lower melt viscosity. A very preferred aspect of the invention is where the use of the additive offers lower melt viscosity, increased fire resistance and supertough behaviour.

Criteria to determine these properties include, for example:

1. Melt viscosity. Melt viscosity measurements can be made using a Kayeness® LCR series capillary rheometer in accordance with ASTM D3835. High flow at high shear rate (above 100 s⁻¹) is of particular interest since high shear rates achieved during thin-wall injection molding; injection molding is a technique which is commonly used for manufacturing aromatic sulfone polymer compositions.

The viscosity of the composition (II) measured at 380° C. under a shear rate of 3513.5 s⁻¹ is advantageously lower than 200 Pa·s, and preferably lower than about 175 Pa·s.

The viscosity of the composition (II) measured at 380° C. under a shear rate of 498.6 s⁻¹ is advantageously lower than 600 Pa·s, preferably lower than 450 Pa·s, and very preferably lower than 300 Pa·s.

The viscosity of the composition (II) measured at 380° C. under a shear rate of 23.2 s⁻¹ is advantageously lower than 800 Pa·s, and preferably lower than 700 Pa·s.

The viscosity of the composition (II) measured at 380° C. under a shear rate of 3513.5 s⁻¹ is advantageously less than 9/10 times the viscosity of composition (I), and preferably less than ⅘ times the viscosity of composition (I), the viscosity of composition (I) being measured at the same temperature and under the same shear rate.

The viscosity of the composition (II) measured at 380° C. under a shear rate of 498.6 s⁻¹ is advantageously less than 9/10 times the viscosity of composition (I), preferably less than ⅘ times the viscosity of composition (I), more preferably less than ⅗ times the viscosity of composition (I), and still more preferably less than ½ times the viscosity of composition (I), the viscosity of composition (I) being measured at the same temperature and under the same shear rate.

The viscosity of the composition (II) measured at 380° C. under a shear rate of 23.2 s⁻¹ is advantageously less than 9/10 times the viscosity of composition (I), preferably less than ⅘ times the viscosity of composition (I), and more preferably less than 7/10 times the viscosity of composition (I), the viscosity of composition (I) being measured at the same temperature and under the same shear rate.

2. Toughness.

The toughness can be measured by the Notched Izod impact testing per ASTM D-256.

Composition (II) has a Notched Izod value, measured by the above test, of advantageously at least ⅓ of the Notched Izod value, preferably at least ⅔ of the Notched Izod value, and still more preferably ⅘ of the Notched Izod value of composition (I), measured in the same conditions.

Supertough behaviour or supertoughness is usually illustrated by a Notched Izod value greater than 10 ft-lb/in and by a ductile failure mode on Notched Izod impact testing per ASTM D-256.

Composition (II) is advantageously supertough.

3. Fire Resistance.

Fire resistance can be measured according to one criterion or a combination of criteria such as low heat release rate, high self-extinguishing properties and low smoke generation, as described herein.

“Increased fire resistance” is intended to denote an improved behaviour to at least one of these criteria.

Composition (II) has advantageously an increased fire resistance relative to composition (I).

4. Heat Release Rate.

Heat release characteristics can be determined by the procedures of Part 25 of Title 14 of the Code of Federal Regulations.

Composition (II) has advantageously a decreased heat release rate under fire conditions relative to composition (I).

Composition (II) meets advantageously the 65/65 1990 compliance levels in these standards for the two minutes total heat release and the maximum heat release rate and preferably show superior heat release performance and vastly exceed the 1990 standards. To this point, the heat release properties of composition (II) were evaluated in accordance with FAR 25. 853 Amendment 25-83, Appendix F, Part IV. Ohio State University (OSU) heat release performance levels of <5 kW/(min·m²) at 2 minutes and a maximum heat release rate of 30-40 kW/m² could be achieved.

5. Self-Extinguishing Properties.

The self-extinguishing properties of the compositions were evaluated in accordance with FAR 25. 853 Amendment 25-83(a) Appendix F, Part L 9a0, 1, (I): 60 sec.

An increase in self-extinguishing properties can correlate with a decreased burn length and/or a decreased burn time.

Composition (II) has advantageously self-extinguishing properties greater than or equal to the self-extinguishing properties of composition (I).

6. Smoke Generation.

Smoke generation can be measured by the smoke density test in accordance with FAR 25.853 (a-1)/ASTM F814/E662.

To the purpose of the invention, a decrease of smoke generation is intended to denote a decrease of at least one of the followings, as measured in accordance with the above test: (i) the smoke density; (ii) the overall toxic gas emission; (iii) the carbon monoxide emission.

The smoke generation under fire conditions of composition (II) is advantageously lower than or equal to the smoke generation under the same fire conditions of composition (I).

The smoke density of composition (II) measured at 4 min according to FAR 25.853 (a-1)/ASTM F814/E662 is advantageously at most 2, and preferably at most 1.

The overall toxic gas emission of composition (II), measured according to BSS 7239-ATS 1000/ABD0031, is advantageously lower than 200 ppm, and preferably lower than 20 ppm.

The carbon monoxide emission of composition (II), measured according to BSS 7239-ATS 1000/ABD0031, is advantageously lower than 100 ppm, and preferably lower than 10 ppm.

The Aromatic Sulfone Polymer.

The aromatic sulfone polymer can be notably any polymer comprising at least 50 mole % of recurring units (Rl) formed by the polycondensation reaction between at least one aromatic dihalocompound comprising at least one —S(═O)₂— group and at least two aromatic rings, and at least one aromatic diol.

The aromatic sulfone polymer comprises preferably at least 80 mole %, and very preferably at least 95 mole %, of recurring units (R1). More preferably, it consists of recurring units (R1).

Examples of suitable aromatic dihalocompounds to the purpose of the present invention are notably dihalobenzene disulfone compounds of the general formula 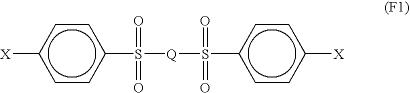
wherein X is a halogen, especially Cl, and Q is a divalent radical susceptible of being obtained by removing two replaceable hydrogens from a molecule of formula QH₂, such as: 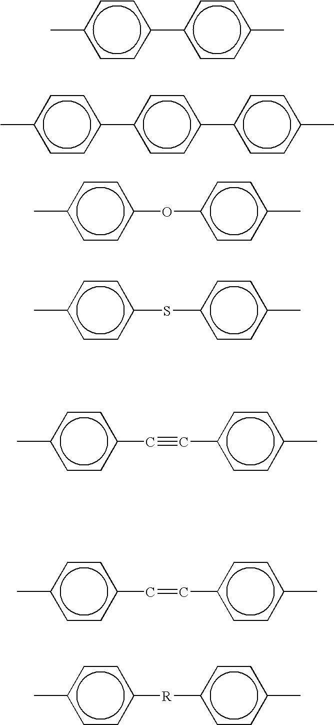
in which R is an aliphatic divalent group of up to 6 carbon atoms such as a methylene, ethylene or isopropylene and the like. Other suitable aromatic dihalocompounds are the 4,4′-dihalodiphenylsulfones.

The aromatic dihalocompound comprises advantageously at most four —S(═O)₂— groups, preferably at most two —S(═O)₂— groups and more preferably at most one —S(═O)₂— group.

The aromatic dihalocompound comprises preferably at most six, preferably at most four aromatic rings, and still more preferably at most two aromatic rings.

Most preferred dihalocompounds are the 4,4′-dihalodiphenylsulfones.

Any aromatic diol which is able to polymerize with the aromatic dihalocompound is suitable. Non limitative examples of such aromatic diols are 4,4′-biphenol (i.e. 4,4′-dihydroxybiphenyl), bisphenol A, 4,4′-dihydroxy-diphenylsulfone (also known as bisphenol S), hydroquinone, and 4,4′-dihydroxy-diphenylether.

The aromatic diol is advantageously free from functional groups other than the —OH groups.

The aromatic diol comprises advantageously at most two aromatic rings. It is preferably chosen from 4,4′-biphenol, bisphenol A, 4,4′-dihydroxy-diphenylsulfone and 4,4′-dihydroxy-diphenylether.

Non limitative examples of aromatic sulfone polymers suitable to the purpose of the present invention are the polyethersulfone consisting of recurring units, 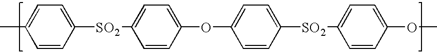
the polyetherethersulfones consisting of recurring units 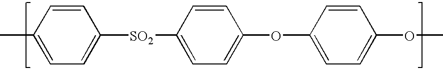
and the copolymers consisting of the above two recurring units, the polybiphenylethersulfones and the bisphenol A polysulfones.

The aromatic sulfone polymer comprises advantageously at least one polybiphenylethersulfone, i.e. a polymer comprising at least 50 mole % of recurring units formed by the polycondensation reaction between at least one 4,4′-dihalodiphenylsulfone and 4,4′-biphenol. Polybiphenylethersulfones consist preferably of recurring units formed by the polycondensation reaction between at least one 4,4′-dihalodiphenylsulfone and 4,4′-biphenol:

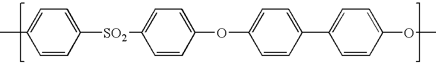

In a preferred embodiment of the present invention, more than 80 wt. % of the aromatic sulfone polymer consist of the polybiphenylethersulfone. In this embodiment, the aromatic sulfone polymer consists more preferably of the polybiphenylethersulfone.

In another preferred embodiment of the present invention, the aromatic sulfone polymer comprises, in addition to the polybiphenylethersulfone, more than 10 wt. % of at least one bisphenol A polysulfone, i.e. a polymer comprising at least 50 mole % of recurring units formed by the polycondensation reaction between at least one 4,4′-dihalodiphenylsulfone and bisphenol A. Bisphenol A polysulfones consist preferably of recurring units formed by the polycondensation reaction between at least one 4,4′-dihalodiphenylsulfone and bisphenol A:

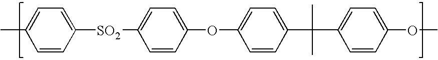

In this embodiment, the aromatic sulfone polymer comprises more preferably more than 20 wt. % of at least one bisphenol A polysulfone; still more preferably, it comprises more than 20 wt. % of at least one bisphenol A polysulfone and more than 70 wt. % of polybiphenylethersulfone.

Composition (II) comprises advantageously at least 65%, preferably at least 75% and more preferably at least 85% by weight (based on the total weight of the composition) of the aromatic sulfone polymer.

The aromatic sulfone polymer may be produced by any suitable method such as those well known in the art and described in U.S. Pat. Nos. 3,634,355; 4,008,203; 4,108,837; and 4,175,175; all of which are incorporated herein by reference.

The molecular weight of the aromatic sulfone polymer is advantageously such that its melt index (measured using ASTM D-1238 at 380 C under a 2.16 kg load be in the range of from about 4 to about 28 g/10 min. Use of an aromatic sulfone polymer, such as a polybiphenyethersulfone, having a melt index lower than 2 g/10 min results usually in materials of lessened melt-fabricability; use of an aromatic sulfone polymer, such as a polybiphenyethersulfone, with a melt index above 28 g/10 min, on the other hand, may result in materials with marginal or unsatisfactory chemical resistance. For injection molding applications, the melt flow range will preferably be 8-20 g/10 minutes for optimal performance.

Examples of commercial aromatic sulfone polymers useful in the compositions according to the present invention include notably UDEL® bisphenol A polysulfones, RADEL® R polybiphenylethersulfones and RADEL® A sulfone polymers; these are available from Solvay Advanced Polymers, L.L.C.

Composition (II) also can have a slightly lower specific gravity.

Flow enhancement allows advantageously composition (II) to be used in thin-wall parts for weight reduction.

The Fluorocarbon Polymer

The fluorocarbon polymer comprising recurring units derived from at least one perfluorinated monoolefin and at least one perfluoroalkylvinylether is advantageously one which, when used alone as additive (A), results in lowering the melt viscosity of sulfone polymer composition (I).

In certain embodiments of the present invention, the fluorocarbon polymer has an essentially crystalline structure and has a melting point in excess of about 120° C.

Suitable perfluorinated monoolefins include notably octafluorobutenes, hexafluoropropylene and tetrafluoroethylene. The perfluorinated monolefin comprises preferably tetrafluoroethylene. Very preferably, the perfluorinated monolefin is tetrafluoroethylene.

To the purpose of the present invention, a “perfluoroalkylvinylether” is intended to denote any ethylenically unsatured compound which is perfluorinated (i.e. in which all the hydrogen atoms have been substituted by fluorine atoms) and which comprises at least one group (G) chosen from —O— (ether group) and —NH— (amino group).

Examples of suitable perfluoroalkylvinylethers include notably perfluoromethylvinylether of formula F₂C═CFOCF₃, perfluoroethylvinylether of formula F₂C═CFOC₂F₅ and perfluoropropylvinylethers of formula F₂C═CFOC₃F₇ where C₃F₇ can either denote an isopropyl or a n-propyl group, and perfluoro-N-methylallylamine of formula F₂C═CF—CF₂—NH—CF₃.

The perfluoralkylvinylether comprises preferably one and only one group (G).

Group (G) is preferably an ether group.

Group (G) is preferably linked to a vinyl or to an allyl group on one hand, and to a C₂-C₂₀ hydrocarbyl group on the other hand. Group (G) is very preferably linked to a vinyl group on one hand, and to a C₂-C₂₀ alkyl group on the other hand.

The alkyl group of the perfluoroalkylvinylether contains preferably up to six carbon atoms, very preferably up to three carbon atoms, and still more preferably one carbon atom.

Good results were obtained when using perfluoromethylvinylether, perfluoroethylvinylether or the perfluoropropylvinylethers as the perfluoralkylvinylether. Excellent results were obtained when using perfluoromethylvinylether as the perfluoralkylvinylether.

Advantageously more than 50 wt. % and preferably more than 90 wt. % of the recurring units contained in the fluorocarbon polymer are derived from at least one perfluorinated monoolefin and at least one perfluoroalkylvinylether. Very preferably, the fluorocarbon polymer consists essentially of recurring units derived from at least one perfluorinated monoolefin and at least one perfluoroalkylvinylether. Still more preferably, the fluorocarbon polymer consists of recurring units derived from at least one perfluorinated monoolefin and at least one perfluoroalkylvinylether.

Very good results were obtained when using copolymers consisting of recurring units derived from tetrafluoroethylene on one hand, and perfluoromethylvinylether, perfluoroethylvinylether or any perfluoropropylvinylether on the other hand, as the fluorocarbon polymer. Excellent results were obtained when using copolymers consisting of recurring units derived from tetrafluoroethylene and perfluoromethylvinylether (MFA copolymers) as the fluorocarbon polymer. MFA copolymers are notably commercially available as HYFLON® from SOLVAY SOLEXIS S.p.A.

Composition (II) comprises advantageously less than 20 wt. %, preferably less than 10 wt. % and more preferably less than 6 wt. %, based on the total weight of composition (II), of the fluorocarbon polymer.

Composition (II) comprises advantageously more than 0.1 wt. %, preferably more than 0.5% and more preferably more than 1 wt. %, based on the total weight of composition (II), of the fluorocarbon polymer.

In certain embodiments, composition (II) comprises 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18 and 19 weight % as well as all values and subranges there between.

In certain embodiments of the present invention, composition (II) comprises a polybiphenylethersulfone polymer, 1-15 wt. %, based on the total weight of composition (II), of MFA, and optionally 0-10% of a liquid crystal polymer (LCP).

Optional Ingredients Contained in Additive (A)

Additive (A) can further comprise, in addition to the fluorocarbon polymer, any ingredient which, when used alone as additive of composition (I), lowers the melt viscosity of composition (I).

In a preferred embodiment of the present invention, additive (A) consists of the fluorocarbon polymer.

In another preferred embodiment of the present invention, additive (A) further comprises a polymer (P) selected from the group consisting of polyetherimides, polycarbonates, poly(aryl ether ketones) and liquid crystalline polymers.

The selection of particular ingredients for additive (A), in addition to the fluorocarbon polymer, and their levels, depends possibly upon the end use envisioned for the material.

For example, for extrusion into sheet form having a thickness less than about 0.125 inches, a composition comprising a high amount of a polybiphenylethersulfone in combination with an additive (A) comprising a poly(aryl ether ketone) in addition to the fluorocarbon polymer, may be preferred; here, a high amount of polybiphenylethersulfone means usually more than 70 weight %, or more than about 75 weight % of the polybiphenylethersulfone based on combined weight of polyphenylsulfone and poly(aryl ether ketone). In injection molding applications, for example, less than 70 weight % or less than about 65 weight % of the polybiphenylethersulfone may be used. Such compositions having more than 70 wt % polybiphenylethersulfone may display poor processing in many injection molding applications, whereas such high levels will provide better processing for extrusion applications.

Poly(aryl ether ketones) encompass the generic description of a class of crystalline aromatic polymers. These resins are readily available from a variety of commercial sources, and methods for their preparation are well known, including the processes described for example in U.S. Pat. Nos. 3,441,538, 3,442,857, 3,516,966, 4,396,755 and 4,816,556; all of which are incorporated herein by reference in their entireties. Commercially available resins include the VICTREX® PEEK poly(aryl ether) ketones, available from Victrex, LTD.

Polymer (P) is preferably a liquid crystalline polymer (LCP). When present in additive (A), the liquid crystal polymer can be in an amount of 10, 20, 30, 40, 50, 70, 80 or 90 weight %, based on the total weight of additive (A), or any other value or subrange there between. In this embodiment, the amount of the liquid crystal polymer ranges preferably from 1 to 6 wt. %, based on the total weight of the composition.

The liquid crystalline polymer is advantageously a wholly aromatic polyester.

Wholly aromatic polyesters are notably commercially available as XYDAR® from SOLVAY ADVANCED POLYMERS L.L.C.

Optional Ingredients Contained in Composition (I)

Optional ingredients contained in composition (I) are advantageously chosen from ingredients which, when used alone as additives of an aromatic sulfone polymer, do not result in lowering the melt viscosity of the aromatic sulfone polymer.

In a preferred embodiment of the present invention, composition (I) consists of the aromatic sulfone polymer.

In another preferred embodiment of the present invention, composition (I) contains one or more ingredients in addition to the aromatic sulfone polymer. The selection of particular additional components, and the levels, depend possibly upon the end use envisioned for the material.

The presence of titanium dioxide would be expected to degrade the mechanical properties of the aromatic sulfone polymer. However, as the Examples below demonstrate, aromatic sulfone polymer compositions that comprise titanium dioxide can be remarkably supertough. Therefore, in a certain embodiment of the present invention, composition (I) also contains titanium dioxide. In another embodiment of the present invention, composition (I) is substantially free of titanium dioxide and, in some cases, free of titanium dioxide, which means no detectable levels of titanium dioxide as measured according to procedures commonly employed in the field.

If present, titanium dioxides suitable for use in the present invention include any commercially available TiO₂. The particle size of the TiO₂ is preferably below about 2 microns because higher particle sizes can deleteriously affect the physical properties of the polymer. Any of the available crystalline forms of the titanium dioxide may be used, with the rutile form preferred due to its superior pigment properties.

The total amount of TiO₂ will preferably be below about 12 weight % based on the total weight of composition (I), inclusive of below 11, 10, 9, 8, 7, 6, 5, 4, 3, 2, and 1 weight % as well as all values and subranges there between, to avoid compounding and processing difficulties. Certain embodiments of the present invention employ about 1 to about 10 weight % TiO₂ since these materials have better processability. In certain other embodiments of the present invention the amount of TiO₂ in the polymer composition ranges from about 7-10 weight %.

In certain embodiments of the present invention, composition (I) comprises a solid filler or reinforcing agent in amounts from about 1 to 50 percent by weight, based on the total weight of composition (I), inclusive of all values and subranges there between. In certain other compositions of the present invention the amount of solid filler or reinforcing is from about 10 to 30 percent, based on the total weight of composition (I).

Fibers which may serve as reinforcing media include, but are not limited to, glass fibers, graphitic carbon fibers, amorphous carbon fibers, synthetic polymeric fibers, aluminum fibers, aluminum silicate fibers, oxide of metals such as aluminum fibers, titanium fibers, magnesium fibers, wollastonite, rock wool fibers, steel fibers, tungsten fibers, etc. Representative filler and other materials include glass, calcium silicate, silica, clays, talc, mica; pigments such as carbon black, iron oxide, cadmium red, iron blue, and other additives such as, wollastonite, graphite, aluminum trihydrate, sodium aluminum carbonate, barium ferrite, etc.

Composition (I) may further include additional additives commonly employed in the resin art such as thermal stabilizers, ultraviolet light stabilizers, plasticizers, and the like.

Composition (II) may be prepared by the compounding processes commonly employed in the resin compounding field. For example, the individual components, commonly provided in the form of chips, pellets or powders, can be physically mixed together in an appropriate apparatus such as a mechanical drum tumbler and then optionally dried, if desired, preferably under vacuum or in a circulating air oven, to remove water from the physical mixture so as to facilitate compounding. The composition of solid polymer particles, which may also including reinforcing filler, fiber pigments, additives, and the like, may then be pelletized, for example by melt extrusion to form a strand which, upon solidification, can be broken up into chips or pellets. It is not necessary to combine all components in a single operation. For example, a composition containing fluorocarbon polymer can be compounded first, and melt blended with the desired amounts of TiO₂ in a later operation.

Composition (II) may be further fabricated by melt processing to form a variety of relatively stiff, shaped articles and molded goods, including molded three-dimensional articles, fibers, films, tapes, and the like, as well as used in forming sheet goods for use in laminating and for coating applications.

Composition (II) can be used to manufacture various articles commonly made with aromatic sulfone polymers. Methods of fabricating such articles can be performed according to the known methods in the field, for example, forming the article using injection molding or extrusion. For example, aircraft components, and particularly, interior components of aircrafts can be made with composition (II).

Further, composition (II) could be used anywhere where shear thinning flow behavior for thin-wall parts, good toughness, and fire resistance (notably, flame resistance) are important. Such applications include, but are not limited to, overhead passenger service units, window reveals, air return grills, wall panels, overhead storage lockers, serving trays, seat backs, cabin partitions, and ducts. Furthermore, another embodiment of the present invention is an aircraft comprising one or more of these aircraft components.

### EXAMPLES

The following examples demonstrate the huge and unexpected improvement in the flowability of a composition comprising an aromatic sulfone based polymer, namely RADEL® R-5000 NT polybiphenylethersulfone, which is obtained when applying the method according to the present invention.

All the polymer resins present in the exemplified compositions were dried in a dehumidifying oven at 150° C. overnight for approximately 16 hours. The compositions were prepared by tumble blending all the ingredients of the aromatic sulfone polymer compositions for approximately 30 minutes. The aromatic sulfone polymer compositions were then extruded using a 25 mm twin screw double vented Berstorff extruder having an L/D ratio of 33:1 at a rate of approximately 25 lb/hr at a screw speed of 200 rpm. The aromatic sulfone polymer compositions were extruded at a melt temperature of 350° C. The first vent port was open to the atmosphere while the second vent port was connected to a vacuum pump. The strands were then passed through a water trough for cooling and then pelletized.

Melt Viscosity.

Melt viscosity measurements were made using a Kayeness® capillary rheometer in accordance with ASTM D3835. 20 g samples of the aromatic sulfone polymer composition were dried at 160° C. for 2 hours prior to testing. Each sample was loaded into the barrel and allowed to melt. A motor driven crosshead with a load transducer used a packing force of 2224 N to drive a piston through a heated steel cylinder maintained at a temperature of 380° C. The sample was forced through a 1.02 mm (0.040 in) diameter, 20.32 mm (0.800 in) long die with an entrance angle of 120° at a controlled rate. The rate and force exerted by the sample were used to calculate the viscosity of the aromatic sulfone polymer composition at each given shear rate tested between 23.2 and 3513.5 s⁻¹.

Properties Other than the Melt Viscosity.

Mechanical Properties. Mechanical properties were evaluated by molding standard 3.2 mm (0.125 in) thick ASTM test specimens for tensile and impact properties. Tensile testing was carried out in accordance with ASTM D-638 and Izod impact testing in accordance with ASTM D256.

Heat Release. The heat release properties of the aromatic sulfone polymer compositions were evaluated in accordance with FAR 25. 853 Amendment 25-83, Appendix F, Part IV. Specimens were prepared by injection molding 6″×6″×0.080″ plaques from the compositions in a Mitsubishi molding press. The samples were mounted vertically in an enclosed chamber and exposed to flame by multiple pilots mounted at the top and bottom of the sample fixture. The samples were simultaneously exposed to a radiant heat flux of 3.5 W/cm² and 85 ft³/min airflow. The heat released during combustion was determined by measuring the difference in temperature of the effluent air from the inlet air.

Vertical Burn Flammability Testing. The self-extinguishing properties of the compositions were evaluated in accordance with FAR 25. 853 Amendment 25-83(a) Appendix F, Part I, 9a0, 1, (I): 60 sec. Specimens were prepared by injection molding standard 3″×12″×0.080″ plaques from the compositions in a Mitsubishi molding press. Specimens were exposed to a burner placed 0.75″ from the bottom of the specimen. The flame was applied for 60 seconds and then removed, and the remaining flaming time was measured. Once the test was finished, the burn length was measured.

Smoke Density. The smoke density testing was performed in accordance with FAR 25.853 (a-1)/ASTM F814/E662. In this test a 3″×3″×0.80″ specimen was exposed to multiple flamelets in combination with a 2.5 W/cm² radiant heat source in an enclosed National Bureau of Standards smoke density chamber. The smoke density was determined by light attenuation of light intensity of a 2200K light source shown vertically up through the test chamber. A microphotometer was used to measure the light intensity. The optical density yielded a measure of the amount of smoke produced when burned. This value was captured after combustion for four minutes.

Toxicity. The smoke density testing was performed in accordance with FAR 25.853 (a-1)/ASTM F814/E662. In this test a 3″×3″×−0.80″ specimen was exposed to multiple flamelets in combination with a 2.5 W/cm² radiant heat source in an enclosed National Bureau of Standards smoke density chamber. The toxicity measurements were made in accordance with the Boeing Specification Support Standard BSS 7239 simultaneously with smoke density measurements. After four minutes of combustion, colorimetric or multigas detector Dräger tubes were used to determine the concentration of six specific gases in the effluent smoke. The gases detected were Hydrogen cyanide (HCN), carbon monoxide (CO), nitrogen oxides (NO+NO₂), sulfur dioxide (SO₂), hydrogen fluoride (HF), and hydrogen chloride (HCl).

TABLE 1

| | Example | | | | | |
|---|---|---|---|---|---|---|
| | CE | E1 | E2 | E3 | E4 | E5 |
| RADEL ® | 96.0% | 94.0% | 91.0% | 92.0% | 86.0% | 63.7% |
| R-5000 NT | | | | | | |
| UDEL ® | | | | | | 27.3% |
| P-3703 NT | | | | | | |
| XYDAR ® | | | | 2.0% | 5.0% | |
| SRT 900 LCP | | | | | | |
| HYFLON ® | | 2.0% | 5.0% | 2.0% | 5.0% | 5.0% |
| MFA 840 | | | | | | |
| TiO2 Kemira | 4.0% | 4.0% | 4.0% | 4.0% | 4.0% | 4.0% |
| OR-470 | | | | | | |

TABLE 2
Melt Viscosity Results

| Rheology @ 380° C. | Example | | | | | |
|---|---|---|---|---|---|---|
| (Pa · s) Shear Rate | CE | E1 | E2 | E3 | E4 | E5 |
| 23.2/s | 1001 | 497 | 474 | 542 | 512 | 617 |
| 104.4/s | 959 | 375 | 306 | 388 | 309 | 348 |
| 498.6/s | 720 | 258 | 231 | 253 | 223 | 230 |
| 1507.4/s | 462 | 240 | 202 | 214 | 181 | 203 |
| 3513.5/s | 223 | 150 | 114 | 164 | 120 | 134 |

Melt viscosity results. All of the examplified sulfone polymer compositions exhibit extremely low melt viscosity under any shear rate in the range 23.2-3513.5 s⁻¹. The method according to the present invention made it possible to lower the melt viscosity of control composition CE by at least about 20%, up to about 60% and more (depending on the shear rate). The examplified compositions have especially an extremely low melt viscosity under a shear rate of 498.6 s⁻¹, below 300 s⁻¹.

Fire resistance results. Tables 3 to 6 show that all the examplified compositions exhibit, in addition to an extremely low viscosity (as illustrated in table 2), a very high level of fire resistance properties, which far exceeds the requirements. With this regard, they perform at least in a comparable fashion and, for some properties like the heat release, better than control composition CE.

TABLE 3
OSU Heat Release Rate Results

| | 2 min HRR | Maximum HRR |
|---|---|---|
| Example | (kW-min/m²) | (kW/m²) |
| CE | 20.9 | 52.8 |
| E1 | 7.6 | 40.6 |
| E2 | 3.0 | 32.7 |
| E3 | 5.0 | 37.6 |
| E4 | 4.0 | 35.0 |
| E5 | 3.6 | 36.4 |
| FAA Requirement | <65 | <65 |

Note:
HRR denotes heat release rate. Test Specification: FAR 25.853 Amendment 25-83, Appendix F, Part IV

TABLE 4
60 Second Vertical Burn

| | Max Burn Time | Max Burn Length | Max Longest Burn |
|---|---|---|---|
| Example | (s) | (in) | Particle (s) |
| CE | 0 | <3.0 | none |
| E1 | 0 | 1.7 | none |
| E2 | 0 | 2.0 | none |
| E3 | 0 | 2.1 | none |
| E4 | 0 | 1.9 | none |
| E5 | 0 | 1.5 | none |
| FAA | <15 | <6 | <3 |
| Requirement | | | |

Test Specification: FAR 25.853(a) Appendix F, part I, (a), 1, (i): 60 sec.

TABLE 5
NBS Smoke Density

| | Max Specific Optical Density |
|---|---|
| Example | (Ds) |
| CE | <3 |
| E1 | 0-1 |
| E2 | 0-1 |
| E3 | 0-1 |
| E4 | 0-1 |
| E5 | <3 |
| FAA | <200 |
| Requirement | |

Note:
Measured at 4.0 minutes.
Test Specification: ABD0031

TABLE 6
Toxic Gas Emission

| | HCN | CO | NO + NO₂ | SO₂ | HF | HC1 |
|---|---|---|---|---|---|---|
| Example | (ppm) | (ppm) | (ppm) | (ppm) | (ppm) | (ppm) |
| CE | <1 | <100 | <1 | <1 | <1 | <1 |
| E1 | <1 | <10 | <1 | <1 | <1 | <1 |
| E2 | <1 | <10 | <1 | <1 | <1 | <1 |
| E3 | <1 | <10 | <1 | <1 | <1 | <1 |
| E4 | <1 | <10 | <1 | <1 | <1 | <1 |
| E5 | <1 | <10 | <1 | <1 | <1 | <1 |
| FAA | <150 | <3500 | <100 | <100 | <100 | <150 |
| Require- | | | | | | |
| ment | | | | | | |

Test Specification: BSS 7239, ATS 1000/ABD0031

Mechanical properties results. Table 7 shows that all the examplified compositions exhibit, in addition to an extremely low melt viscosity (as illustrated in table 2), an extremely high level of toughness, commonly referred to as “supertoughness” or “supertough behaviour” (notched Izod impact strength above 10 ft-lb/in and ductile fracture at the notched Izod impact test).

TABLE 7
Mechanical Properties Results

| | Tensile | | Notched | Notched |
|---|---|---|---|---|
| | Yield | Tensile | Izod | Izod - |
| | Strength | Modulus | Impact | Type of |
| Example | (psi) | (kpsi) | (ft-lb/in) | fracture |
| CE | 10500 | 350 | 13.0 | ductile |
| E1 | 10090 | 339 | 10.8 | ductile |
| E2 | 9740 | 330 | 10.7 | ductile |
| E3 | 10080 | 348 | 10.7 | ductile |
| E4 | 10080 | 353 | 20.2 | ductile |
| E5 | 10040 | 343 | 11.0 | ductile |

All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out.

Obviously, numerous modifications and variations of the present invention are possible in light of the above teachings. It is therefore to be understood that within the scope of the appended claims, the invention may be practiced otherwise than as specifically described herein.

1-23. (canceled)

24. A method for lowering the melt viscosity of an aromatic sulfone polymer composition in need thereof said aromatic sulfone polymer composition comprising at least one aromatic sulfone polymer, said method comprising adding to composition (I) a melt viscosity lowering amount of an additive composition comprising at least one fluorocarbon polymer comprising recurring units derived from at least one perfluorinated monoolefin and at least one perfluoroalkylvinylether to form composition II.

25. (canceled)

26. The method according to claim 24, wherein composition (II) has a viscosity measured at 380° C. under a shear rate of 498.6 s⁻¹ lower than 600 Pa·s.

27. The method according to claim 24, wherein composition (II) has a viscosity measured at 380° C. under a shear rate of 498.6 s⁻¹ of less than ½ times the viscosity of composition (I), measured at the same temperature and under the same shear rate.

28. The method according to claim 24, wherein composition (II) is supertough.

29. The method according to claim 24, wherein composition (II) has a greater fire resistance than of composition (I).

30. The method according to claim 29, wherein composition (II) has a heat release rate under fire conditions lower than composition (I).

31. The method according to claim 24, wherein the aromatic sulfone polymer comprises at least one polybiphenylethersulfone.

32. The method according to claim 31, wherein more than 80 wt. % of the aromatic sulfone polymer consists of the polybiphenylethersulfone.

33. The method according to claim 31, wherein the aromatic sulfone polymer further comprises more than 20 wt. % of at least one bisphenol A polysulfone.

34. The method according to claim 24, wherein:
composition (II) is supertough, and
composition (II) has a greater fire resistance than of composition (I), including a heat release rate under fire conditions lower than composition (I), and
the aromatic sulfone polymer composition comprises at least one polybiphenylethersulfone, more than 80 wt. % of the aromatic sulfone polymer consisting of the polybiphenylethersulfone.

35. The method according to claim 24, wherein:
composition (II) is supertough, and
composition (II) has a greater fire resistance than composition (I), including a heat release rate under fire conditions lower than composition (I), and
the aromatic sulfone polymer composition comprises at least one polybiphenylethersulfone and, in addition, more than 20 wt. %, based on the total weight of the sulfone polymer, of at least one bisphenol A polysulfone.

36. The method according to claim 24, wherein the fluorocarbon polymer comprises recurring units derived from tetrafluoroethylene and perfluoromethylvinylether.

37. The method according to claim 24, wherein:
composition (II) is supertough, and
composition (II) has a greater fire resistance than composition (I), including a heat release rate under fire conditions lower than composition (I), and
the aromatic sulfone polymer composition comprises at least one polybiphenylethersulfone, more than 80 wt. % of the aromatic sulfone polymer consisting of the polybiphenylethersulfone, and
the fluorocarbon polymer comprises recurring units derived from tetrafluoroethylene and perfluoromethylvinylether.

38. The method according to claim 24, wherein composition (II) comprises less than 10 wt. %, based on the total weight of composition (II), of the fluorocarbon polymer.

39. The method according to claim 24, wherein additive (A) further comprises a polymer selected from the group consisting of polyetherimides, polycarbonates, poly(aryl ether ketones), and liquid crystalline polymers.

40. The method according to claim 24, wherein:
composition (II) is supertough, and
composition (II) has a greater fire resistance than composition (I), including a heat release rate under fire conditions lower than composition (I), and
the aromatic sulfone polymer composition comprises at least one polybiphenylethersulfone, more than 80 wt. % of the aromatic sulfone polymer consisting of the polybiphenylethersulfone, and
additive (A) further comprises a polymer selected from the group consisting of polyetherimides, polycarbonates, poly(aryl ether ketones), and liquid crystalline polymers.

41. The method according to claim 24, wherein composition (II) is free of inorganic flame retardant or comprises inorganic flame retardant in an amount of less than 2 pbw, based on the weight of the aromatic sulfone polymer.

42. The method according to claim 24, wherein composition (II) is free of titanium dioxide or comprises titanium dioxide in an amount of less than 3 pbw, based on the weight of the aromatic sulfone polymer.

43. The method according to claim 24, wherein composition (II) comprises titanium dioxide in an amount of at least 3 pbw, based on the weight of the aromatic sulfone polymer.

44. (canceled)

45. (canceled)

46. An aromatic sulfone polymer composition comprising:
at least one aromatic sulfone polymer, and
an additive comprising at least one fluorocarbon polymer comprising recurring units derived from at least one perfluorinated monoolefin and at least one perfluoroalkylvinylether,
wherein composition (II) has a melt viscosity lower than the melt viscosity of the same composition without additive (A).

47. An aircraft component comprising the aromatic sulfone polymer composition according to claim 46.

48. The aircraft component according to claim 47, which is selected from the group consisting of an overhead passenger service unit, a window reveal, an air return grill, an aircraft wall panel, an aircraft overhead storage locker, an aircraft serving tray, an aircraft seat back, an aircraft cabin partition, and an aircraft duct.

49. An aircraft comprising the aircraft component according to claim 47.
